(19) United States
(12) Patent Application Publication
(10) Pub. No.: US 2026/0057804 A1
(43) Pub. Date: Feb. 26, 2026

(54) VASCULAR MODELS AND USES THEREOF

(71) Applicant: REPERFUSE IP PTY LTD, North Geelong, Victorla (AU)

(72) Inventors: Andrew HATTAM, North Geelong, Victoria (AU); Enis KOCAK, North Geelong, Victoria (AU)

(21) Appl. No.: 19/483,272

(22) PCT Filed: May 10, 2024
(86) PCT No.: PCT/AU2024/050459

§ 371 Date: Nov. 11, 2025

(30) Foreign Application Priority Data
May 11, 2023 (AU) 2023901441

(51) Int. Cl. G09B 23/30

(52) U.S. Cl. CPC G09B 23/303; G09B 23/306

(57) ABSTRACT

The present disclosure relates to vascular models, uses thereof and methods for simulating vascular surgery techniques, particularly endovascular surgery techniques.

### CROSS-REFERENCE TO RELATED APPLICATION

This application claims priority from Australian Provisional Patent Application No. 2023901441 filed 11 May 2023, the entire contents of which are incorporated herein by cross-reference.

### TECHNICAL FIELD

The present disclosure relates to vascular models, uses thereof and methods for simulating vascular surgery techniques, particularly endovascular surgery techniques.

### BACKGROUND

Vascular diseases, including cardiovascular disease, stroke and peripheral vascular disease (PVD), are a leading cause of death worldwide. In Australia alone, around 1.2 million people suffer from at least one vascular disease, with many of those requiring vascular surgery at some stage throughout their life.

Vascular surgery training requires access to models for the vascular system that are able to mimic vascular disease states. Cadaver-based surgical simulation has been demonstrated to be superior to both low fidelity simulation training and no simulation training at all. Although mostly utilised for traditional “open” surgical techniques, with extension to camera-based laparoscopic and robotic surgery, cadaver-based surgical simulation remains limited in its ability to mimic active blood-flow. As such, simulation of surgery on the blood-filled circulatory (or vascular) system via traditional open vascular or angiography-based endovascular surgery is commonly performed in synthetic models, anaesthetised animals, or limited sections of a cadaver.

However, perfused cadaver models have numerous limitations. For example, existing synthetic models are not able to replicate the variations in true human anatomy or tactile feedback provided by living or human tissue, and do not allow for the use of techniques that rely on the material characteristics of native tissue or implantable surgical devices that conform and expand to the anatomy of living or human tissue. Animal models are also undesirable because, in addition to the ethical considerations such models pose, they require veterinary and animal anaesthetics and surgical facilities, have differing anatomy (including vascular anatomy) to humans, and have different tissue handling and endoluminal handling characteristics compared to humans.

While cadaver models are preferable, current techniques to perfuse large circulation territories are limited by use of potentially toxic and/or flammable perfusates, non-physiological perfusate flow patterns, and fluid leakage (and therefore pressure loss) from primary branches of the main blood vessels of the body. Leakage of perfusate can also result in pooling of contrast-containing solutions within the cadaver tissues. This pooling eventually opacifies and blurs tissue on x-ray imaging, impeding further imaging of the cadaver vascular system. Moreover, current models are limited to study of the main arteries of the body, namely the aorta and iliac arteries, and are therefore limited in their applicability to arterial branches beyond the aorta and iliac arteries.

Accordingly, there is an ongoing need for improved or alternative models for the perfused vascular system.

### SUMMARY

In one aspect, the present disclosure provides a vascular model comprising a cadaver and an external drive unit in fluid communication with a vascular system of the cadaver and with a perfusate reservoir, wherein the vascular system includes an inlet through which perfusate enters an aorta and an outlet through which perfusate exits a primary or higher order branch of an aorto-iliac artery, and wherein the external drive unit is configured to generate a continuous flow of perfusate from the inlet to the outlet.

In another aspect, the present disclosure provides a vascular model comprising a cadaver and an external drive unit in fluid communication with a vascular system of the cadaver and with a perfusate reservoir, wherein the vascular system includes an inlet through which perfusate enters a vena cava, or a primary or higher order tributary thereof, and an outlet through which perfusate exits the vena cava, and wherein the external drive unit is configured to generate a continuous flow of perfusate from the inlet to the outlet.

A vascular model comprising a cadaver and an external drive unit in fluid communication with a vascular system of the cadaver and with a perfusate reservoir, wherein the vascular system includes a first inlet through which perfusate enters an aorta and a first outlet through which perfusate exits a primary or higher order branch of an aorto-iliac artery, and a second inlet through which perfusate enters a vena cava, or a primary or higher order tributary thereof, and a second outlet through which perfusate exits the vena cava, and wherein the external drive unit is configured to generate a continuous flow of perfusate from the first inlet to the first outlet and from the second inlet to the second outlet.

In another aspect, the present disclosure provides use of the vascular model in accordance with the present disclosure for simulating a vascular surgery technique.

In another aspect, the present disclosure provides a method for simulating a vascular surgery technique, the method comprising performing a vascular surgery technique on the vascular model in accordance with the present disclosure.

### GENERAL DEFINITIONS

Unless defined otherwise, all technical and scientific terms used herein have the same meanings as commonly understood by one of ordinary skill in the art to which this disclosure belongs.

Unless otherwise specified, the indefinite articles “a”, “an” and “the” as used herein, include plural aspects. Thus, for example, reference to “an agent” includes a single agent, as well as two or more agents; reference to “the composition” or “formulation” includes a single composition or formulation, as well as two or more compositions or formulations; and so forth.

As used herein, the term “and/or” includes any and all combinations of one or more of the associated listed items.

As used herein, the term “about”, as applied to one or more values, refers to a value that is similar to a stated reference value. In certain embodiments, the term “about” refers to a range of values that fall within 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value). In a particular embodiment, the term “about” means±10% of the recited value.

Throughout this specification and the claims that follow, unless the context requires otherwise, the word “comprise”, and variations such as “comprises” and “comprising”, will be understood to imply the inclusion of a stated integer or step or group of integers or steps but not the exclusion of any other integer or step or group of integers or steps. The term “consisting of” means “consisting only of”, that is, including and limited to the integer or step or group of integers or steps, and excluding any other integer or step or group of integers or steps. The term “consisting essentially of” means the inclusion of the stated integer or step or group of integers or steps, but other integer or step or group of integers or steps that do not materially alter or contribute to the working of the disclosure may also be included.

The reference to any prior art in this specification is not, and should not be taken as, an acknowledgment or any form of suggestion that that prior art forms part of the common general knowledge.

Other definitions may be provided throughout the specification.

### DETAILED DESCRIPTION

The present disclosure relates to models of the vascular system (i.e., vascular models) for simulating vascular surgery techniques, including surgical diagnostic techniques. The present inventors surprisingly found that the vascular models of the present disclosure may more accurately simulate the human circulatory system than existing models by allowing for distal perfusion of multiple blood vessels. Thus, the vascular models disclosed herein may advantageously provide a more realistic simulation of human blood flow and provide tactile feedback that more closely mimics that of live tissue compared to existing vascular models. Further, in contrast to existing models, the vascular models of the present disclosure may enable a broader range of vascular surgery techniques to be simulated by providing a larger and more complete model of the vascular system. Thus, the models of the present disclosure may be useful as a training model for vascular surgery techniques, particularly endovascular surgery techniques.

The vascular system (also known as the circulatory system) is a system of blood vessels in a body (e.g., a human body), including arteries that carry blood throughout the body to different organs and veins that return blood from those organs to the heart. It is to be understood that any reference to a “vascular system” of a cadaver herein may be a reference to the complete vascular system, or a portion of the vascular system comprising the blood vessels of interest (e.g., the arterial system, the venous system, or portions thereof). In certain embodiments, a portion of the vascular system may be isolated in the vascular models disclosed herein, for example, by creating artificial blockages in one or more blood vessels. Suitable techniques for creating artificial blockages may depend on the location of the blockage and/or the device being used or tested, and will be apparent to those skilled in the art.

Advantageously, the vascular models disclosed herein may be used to simulate both the arterial and venous vascular systems. Thus, a vascular model in accordance with the present disclosure may be an arterial vascular model, a venous vascular model, or both (i.e., simultaneously an arterial vascular model and a venous vascular model). In the context of the present invention, an “arterial vascular model” refers to a model of the arteries, or a portion thereof, of a vascular system. In a particular embodiment, an arterial vascular model as described herein may comprise the aorto-iliac arteries and at least one primary branch thereof and, optionally, one or more higher or branches thereof. Similarly, in the context of the present invention, a “venous vascular model” refers to a model of the veins, or a portion thereof, of a vascular system. In a particular embodiment, a venous vascular model as described herein may comprise the vena cava (i.e., the superior vena cava, inferior vena cava, or both) and, optionally, at least one primary or higher order tributary thereof.

Generally, vascular models in accordance with the present disclosure comprise a cadaver and an external drive unit in fluid communication with a vascular system of the cadaver and with a perfusate reservoir, wherein the vascular system includes an inlet through which perfusate enters a first blood vessel and an outlet through which perfusate exits a second blood vessel, and wherein the external drive unit is configured to generate a continuous flow of perfusate from the inlet to the outlet. When the vascular model is an arterial vascular model, the first blood vessel is an aorta and the second blood vessel is a primary or higher order branch of an aorto-iliac artery. When the vascular model is a venous vascular model, the first blood vessel is a vena cava or a primary or higher order tributary thereof and the second vessel is the vena cava.

The vascular models disclosed herein comprise a cadaver. As used herein, the term “cadaver” refers to a deceased human body. However, it is also contemplated that the models of the present invention may be adapted for use in a veterinary setting, particularly as a model for mammalian vascular systems (i.e., using a deceased mammal body). Such mammals may include but are not limited to primates, livestock animals (e.g., horses, cattle, sheep, pigs, donkeys), laboratory test animals (e.g., mice, rats, guinea pigs), companion animals (e.g., dogs, cats) and captive wild animals (e.g., kangaroos, deer, foxes).

The cadaver may be a whole cadaver, or it may be a portion of the cadaver comprising the arteries and/or veins of interest. For example, the cadaver may have been surgically modified, e.g., by the removal of one or more limbs or other appendages, and/or by the removal of one or more organs (e.g., for organ donation and/or to aid use of the cadaver as a vascular model). Cadavers may be fresh (i.e., recently deceased), or they may have been frozen, preferably fresh frozen, for a period of time (e.g., days, weeks, months or years) prior to use in the vascular models disclosed herein. Frozen cadavers may be thawed prior to use, for example, using warm water irrigation. Cadavers may be embalmed or non-embalmed. Suitable cadavers may be procured from registered bequest programs and ethics approval should be obtained before using a cadaver or other deceased animal in the vascular models, kits, uses and methods of the present disclosure.

Removal of one or more internal organs from the cadaver may be desirable to aid its use in a vascular model as described herein. For example, certain organs (e.g., the heart, one or both lungs) may be removed from the cadaver to aid exposure to the target blood vessels (e.g., arteries and/or veins), and/or improve angiography images of the relevant blood vessels. Further, exposure of the main arteries and/or veins of the abdomen may be aided by removal of some or all the gastro-intestinal contents (oesophagus, stomach, small bowel, and large bowel) without significant disruption to the arteries or veins. Advantageously, removal of some or all the gastro-intestinal contents may prolong cadaver use, reduce leakage from smaller blood vessels, and/or improve angiographic results.

The vascular models disclosed herein are perfused vascular models. As used herein, the term “perfused” with reference to a vascular model means a vascular model comprising a cadaver in which a fluid, also known as a “perfusate”, is transmitted through the vascular system of the cadaver, thereby simulating the passage of blood through the blood vessels of interest. As used herein, the term “perfusate” refers to any fluid suitable for simulating the passage of blood through the vascular system, or a portion thereof. Suitable perfusates may include but are not limited to water, saline, glycerol, gelatinous colloids (e.g., albumin), or combinations thereof. Other suitable perfusates will be apparent to those skilled in the art.

A perfusate may enter the vascular system of a cadaver through an inlet in a first blood vessel, and exit the vascular system through an outlet in a second blood vessel. A skilled person will be able to select suitable blood vessels for providing inlets and outlets for the perfusate depending on the vascular surgery technique to be simulated. It is to be understood that the perfusate may enter the vascular system through an inlet in one or more (e.g., two, three, four, or more) blood vessels and/or exit the vascular system through an outlet in one or more (e.g., two, three, four, or more) blood vessels. Advantageously, the inclusion of one or more outlets from which a perfusate can exit a vascular system (e.g., in an arterial vascular model) or inlets through which a perfusate can enter a vascular system (e.g., in a venous vascular model) may reduce or prevent leakage and/or pooling of perfusate within cadaveric tissues.

An inlet or outlet may be provided in a blood vessel (e.g., an artery or vein) using any suitable means known in the art. For example, an inlet and/or outlet may be provided in a blood vessel by making an incision in the blood vessel, into which a tube (e.g., a cannula) may be inserted. Alternatively, the blood vessel may be severed and a tube inserted into or attached (e.g., using a clamp, tie or suture) to the blood vessel. Thus, it is to be understood that any reference herein to a blood vessel includes a portion of that vessel (e.g., a severed or detached portion of the blood vessel). In some embodiments, the inlet and/or outlet may further comprise a suitable conduit (e.g., a Dacron graft) into the blood vessel.

In an arterial vascular model of the present disclosure, the perfusate may enter the vascular system through an inlet in an aorta and exit the vascular system through an outlet in a primary or higher order branch of an aorto-iliac artery (an “outlet” artery). The aorto-iliac arteries comprise an aorta and a common iliac artery. Where multiple outlets are provided, each outlet may be independently provided in a primary or a higher order branch of the aorto-iliac arteries. As used herein, a “branch” of a reference artery refers to an artery into which the reference artery directly empties (i.e., drains). Primary branches of an artery refer to those blood vessels that are directly connected to the artery. An artery directly connected to a primary branch is referred to as a secondary branch, an artery directly connected to a secondary branch is referred to as a tertiary branch, and so on. The arterial vascular model may comprise one or more higher order (e.g., secondary, tertiary, quaternary, or higher) branches. In the context of the present invention, a “branch” may include a continuation of an artery (e.g., wherein the artery continues by a different name, for example, after traversing a particular anatomical structure).

Examples of primary branches of the aorto-iliac arteries include but are not limited to a brachiocephalic artery, a left common carotid artery, a left subclavian artery, an external iliac artery and an internal iliac artery. The outlet artery may be one or more higher order branches of the aorto-iliac arteries. For example, a secondary branch of the aorto-iliac arteries may include an artery directly connected to (or continuing from) a brachiocephalic artery (e.g., the right common carotid artery, right subclavian artery, right axillary artery, right brachial artery, right radial artery and right ulnar artery), left common carotid artery (e.g., the external carotid artery and internal carotid artery), left subclavian artery (e.g., the vertebral artery, internal thoracic artery, thyrocervical trunk, costocervical trunk, dorsal scapular artery, axillary artery, brachial artery, radial artery and ulnar artery), external iliac artery (e.g., the inferior epigastric artery, deep circumflex iliac artery, common, superficial and deep femoral arteries, popliteal, peroneal, posterior and anterior tibial arteries) or internal iliac artery (e.g., the iliolumbar artery, lateral sacral artery, superior and inferior gluteal arteries, internal pudendal artery, inferior vesical artery, middle rectal artery, obturator artery, superior vesical artery and uterine artery). Other higher order branches of the aorto-iliac arteries will be apparent to those skilled in the art.

In an embodiment, the perfusate exits the vascular system through an outlet in a radial artery, an ulnar artery, a brachial artery, an axillary artery, a subclavian artery, an internal carotid artery, an external carotid artery, a coeliac trunk artery, a hepatic artery, a splenic artery, a renal artery, a superior mesenteric artery, an inferior mesenteric artery, an anterior tibial artery, a posterior tibial artery, a dorsalis pedis artery, a peroneal artery, a popliteal artery, a common femoral artery, a deep femoral artery, a superficial femoral artery, an internal iliac artery, or any combination thereof.

In a particular embodiment, the perfusate exits the vascular system through an outlet in the left common carotid artery.

In a particular embodiment, the perfusate exits the vascular system through an outlet in the common femoral artery, a deep femoral artery, a superficial femoral artery, or any combination thereof.

In a venous vascular model of the present disclosure, perfusate may enter the vascular system through an inlet in a vena cava or a primary or higher order tributary thereof (an “inlet” vein), and exit the vascular system through an outlet in the vena cava. The vena cava may comprise the superior vena cava, inferior vena cava, or both. The inlet vein may be the vena cava, or any primary or higher order tributary thereof. Thus, in an embodiment, the perfusate may enter the vascular system through an inlet in a vena cava and exit the vascular system through an outlet in the vena cava. In another embodiment, the perfusate may enter the vascular system through an inlet in a primary or higher order tributary of a vena cava and exit the vascular system through an outlet in the vena cava. Where multiple inlets are provided, each inlet may be independently provided in a vena cava, or a primary tributary or a higher order tributary thereof. As used herein, a “tributary” of a reference vein refers to a vein that empties (i.e., drains) directly into the reference vein. Primary tributaries of a vein refer to those blood vessels that empty directly into the vein. A vein that empties directly into a primary tributary is referred to as a secondary tributary, a vein that empties directly into a secondary tributary is referred to as a tertiary tributary, and so on. The venous vascular model may comprise one or more higher order (e.g., secondary, tertiary, quaternary, or higher) tributaries. In the context of the present invention, a “tributary” may include a continuation of a vein (e.g., wherein the vein continues by a different name, for example, after traversing a particular anatomical structure).

Examples of primary tributaries of the superior vena cava include but are not limited to brachiocephalic veins. Examples of primary tributaries of the inferior vena cava include but are not limited to a lumbar vein, a right gonadal vein, a renal vein, a right suprarenal vein, a phrenic vein, a common iliac vein and a hepatic vein. The inlet vein may be one or more higher order tributaries of the superior and/or inferior vena cava. For example, a secondary tributary of the superior vena cava may include a vein that empties directly into (or continues into) a brachiocephalic vein (e.g., external and/or internal jugular vein, vertebral vein, internal thoracic vein, inferior thyroid vein, subclavian, axillary, brachial, cephalic and/or basilic vein). A secondary tributary of the inferior vena cava may include a vein that empties directly into the lumbar vein (e.g., iliac veins, epigastric vein, superficial epigastric vein, circumflex iliac and lateral thoracic veins; internal and external vertebral venous plexuses), right gonadal vein, renal veins (e.g., capsular veins, left gonadal vein, left inferior phrenic vein and left adrenal vein), right suprarenal vein, phrenic vein, common iliac vein (e.g., inferior epigastric vein, deep circumflex iliac vein, pubic vein) and hepatic vein (e.g., umbilical fissure vein). Other higher order tributaries of the superior vena cava and inferior vena cava will be apparent to those skilled in the art.

In an embodiment, perfusate enters the vascular system through an inlet in a cephalic, vein, a basilic vein, a brachial vein, an axillary vein, a subclavian vein, an internal jugular vein, an external jugular vein, a brachiocephalic vein, a popliteal vein, a saphenous vein, a lumbar vein, a right gonadal vein, a renal vein, a right suprarenal vein, an inferior phrenic vein, a hepatic vein, a common iliac vein, a portal vein, an internal iliac vein, an external iliac vein, a mesenteric vein, a deep femoral vein, a femoral vein, or any combination thereof.

The perfusate may be provided at any suitable temperature, preferably at human body temperature. For example, the perfusate may be provided at ambient temperature, or it may be provided at a temperature of between about 30° C. and about 40° C., preferably between about 36° C. and about 37° C. Providing the perfusate at body temperature may be particularly advantageous, for example, when the vascular model is used for implantable devices that conform to the blood vessels upon implantation. For example, many implantable stent devices are made of nickel titanium (nitinol) and are collapsed on delivery, expanding to assume their original shape upon warming in the body (e.g., Abre™ venous self-expanding stent system; Medtronic). Perfusates that mimic the viscosity of human blood may also be particularly advantageous and may be treated, if necessary, with a viscosity-modifying agent or thickening agent (e.g., a glycerol-based thickening agent) to achieve the desired viscosity. Other agents may be added to the perfusate to more closely mimic human blood, such as a colouring agent or protein (e.g., gelatinous albumin).

The perfusate may further comprise one or more contrast agents for increasing the contrast of structures or fluids within the body during medical imaging (e.g., x-ray, CT, MRI, or the like). Advantageously, the use of contrast agents may enable vascular surgery techniques to be simulated that typically involve monitoring in real time using medical imaging techniques. For example, angiography is a procedure that typically involves a liquid contrast agent being injected into the bloodstream to make blood vessels visible on an x-ray scan. A skilled person will be able to readily select a suitable contrast agent depending on the type of procedure and/or type of medical imaging to be performed. For example, suitable contrast agents may include but are not limited to iodine-based, barium-based and gadolinium-based contrast agents. Preferably, when a perfusate comprises a contrast agent, recirculation of the perfusate into the vascular system of the cadaver may be limited to a certain number of cycles that avoids excess build-up of the contrast agent in the blood vessels. For example, the recirculated of the perfusate may be limited to two, three or four cycles, after which the perfusate is discarded and replaced with new perfusate.

A perfusate reservoir may be housed in any suitable container, for example, a bucket. A suitable container may also be provided for collecting used perfusate as it exits the cadaver. Alternatively, used perfusate may be returned to the perfusate reservoir for recirculation into the cadaver. The used perfusate may be filtered (e.g., to remove particulate matter) before being returned to the perfusate reservoir for recirculation into the cadaver. In embodiments in which the vascular model simultaneously comprises an arterial model and a venous model, upon exiting the arterial model through the outlet of the primary or higher order branch of the aorto-iliac artery, the used perfusate may be recirculated into the venous model through the inlet of the primary or higher order tributary of the vena cava. Alternatively, the arterial model and venous model may operate independently of one another (e.g., using separate perfusate reservoirs, pumps, etc.).

The vascular models disclosed herein further comprise an external drive unit in fluid communication with a vascular system of a cadaver and with a perfusate reservoir. The external drive unit may comprise any suitable device(s) (e.g., one or more pumps and/or vacuum systems) configured to generate a continuous flow of perfusate from the relevant inlet to the relevant outlet. As used herein, a “continuous flow” with reference to a perfusate means a substantially unidirectional and uninterrupted flow of perfusate and includes a pulsatile flow. In an embodiment, the external drive unit comprises one or more pump systems. The pump system(s) may comprise a pump and one or more tubes for transmitting a perfusate from a perfusate reservoir through an inlet to a first blood vessel of a vascular system and through an outlet in a second blood vessel. The pump may be a laminar (continuous flow) pump or a pulsatile pump. In a particular embodiment, the pump is configured to provide a pulsatile flow of perfusate (i.e., a pulsatile pump), which may more accurately simulate blood flow in a body. In an embodiment, the pump is a submersible pump. Suitable external drive units will be apparent to those skilled in the art, and may include commercially available aquarium pumps.

The external drive unit may be configured to generate a continuous flow of the perfusate at a pressure that approximates a blood pressure observed in humans (or other animals, particularly mammals). For example, arterial blood pressure in an adult human typically ranges from about 80 mmHg to about 200 mmHg systolic and from about 50 mmHg to about 100 mmHg diastolic, whereas venous blood pressure in an adult human typically ranges from about 0 mmHg to about 10 mmHg. Thus, an external drive unit suitable for use in an arterial vascular model as disclosed herein may be configured to generate a continuous flow of the perfusate at a pressure of between about 0 mmHg and about 200 mmHg, or between about 50 mmHg and about 200 mmHg. An external drive unit suitable for use in a venous vascular model as disclosed herein may be configured to generate a continuous flow of the perfusate at a pressure of between about 0 mmHg and about 50 mmHg, or between about 0 mmHg and about 10 mmHg. A skilled person will be able to select a suitable external drive unit (e.g., a pump system or vacuum system) and pressure depending on whether the pump system is intended for use in an arterial vascular model, venous vascular model, or both, and adjust the pressure as necessary, for example, to minimise leakage of perfusate from the blood vessels.

The present disclosure also provides kits for simulating vascular surgery techniques. The kit may include, for example, one or more components of an external drive unit as described herein (e.g., a pump/vacuum and/or tubing), each packaged individually, or packaged in combination. Such kits may further comprise one or more additional components. Such additional components may include, but are not limited to, a perfusate, a contrast agent, a filter, a reservoir, clamps, ties, cannulas, and the like, or any combination thereof. The constituent components of the kits disclosed herein may be placed within a package, and the package may optionally include instructions for use. The kits may optionally comprise instructions describing a method of using the kits in one or more of the methods described herein.

The present disclosure also provides methods for simulating vascular surgery techniques, including arterial and venous vascular surgery techniques. In an embodiment, the present disclosure provides a method for simulating a vascular surgery technique comprising performing a vascular surgery on a vascular model as disclosed herein. The vascular surgery technique may be an arterial vascular surgery technique, a venous vascular surgery technique, or a combination thereof. In an embodiment, the vascular surgery technique is an endovascular surgery technique.

Advantageously, more than one vascular surgery technique may be simulated using a single cadaver in the vascular models disclosed herein, either simultaneously or sequentially. As used herein, the term “vascular surgery” refers to a surgery performed on the vascular system and includes traditional (“open”) vascular surgery, endovascular surgery, and hybrid surgeries involving both open and endovascular surgery techniques. As used herein, the term “endovascular surgery” refers to vascular surgery performed from within the blood vessel using minimally invasive techniques, including percutaneous techniques (i.e., minimally invasive procedures performed through keyhole puncture incisions in the skin) and angiographic techniques (i.e., in which a liquid contrast agent is injected into the bloodstream to render blood vessels visible on an x-ray scan).

The vascular models, kits, uses and methods disclosed herein may be useful for simulating a broad range of vascular surgery techniques, particularly endovascular surgery techniques, which involve minimally invasive procedures done through keyhole puncture incisions in the skin. Such vascular models and methods may be suitable for simulating existing arterial and/or venous endovascular techniques, as well as emerging surgical technologies. This may provide certain advantages over existing techniques, including venous vascular systems, which typically simulate blood flow through the venous system by establishing isolated venous system models or by combining both the arterial and venous systems with recirculation of contaminated arterial perfusate into the venous system.

Arterial endovascular surgery techniques that may be simulated using the vascular models, kits, uses and methods disclosed herein may include but are not limited to: endovascular arterial access via the upper limbs, neck, chest, abdomen, groin, and lower limbs; testing and use of percutaneous arterial puncture closure devices; percutaneous and open endovascular arterial access and injury repair; diagnostic angiography; angioplasty; embolization; atherectomy; thrombo-endarterectomy; and stenting (including grafts) of arteries or their branches (e.g., radial, ulnar, brachial, axillary, subclavian, brachiocephalic trunk, vertebral, common, internal and external carotid, aorta, coeliac trunk, hepatic, splenic, superior mesenteric, renal, common and external iliac, superficial and deep femoral, popliteal, posterior tibial, anterior tibial, and peroneal arteries), and extra-corporeal circulation circuit for extra-corporeal membrane oxygenation (ECMO); or any combination thereof.

Such arterial endovascular surgery techniques may be useful, for example, in the treatment of atherosclerosis, aneurysm disease, arterial dissection, arterial clots, portal hypertension (liver failure), or arterial trauma. Such conditions may be present in the cadaver, or they may be simulated in the cadaver. By way of non-limiting example, an aneurysm may be simulated using a patch consisting of either cadaveric pericardium or abdominal fascia, or an aortic dissection may simulated by introducing perfusate into the tissue layers making up the aorta.

Venous endovascular surgery techniques that may simulated using the models, kits, uses and methods disclosed herein may include but are not limited to: endovascular venous access via the upper limbs, neck, chest, abdomen, groin, and lower limbs; testing and use of percutaneous venous puncture closure devices; percutaneous and open endovascular venous access and injury repair; diagnostic angiography; angioplasty; embolization; atherectomy; thrombo-endarterectomy; radio-frequency ablation; application of laser, glue and sclerosing agents; and stenting (including grafts) of veins and their tributaries (e.g., cephalic, basilic, brachial, axillary, subclavian, brachiocephalic, vertebral, internal and external jugular, superior and inferior vena cava, portal, hepatic, splenic, superior and inferior mesenteric, renal, common, internal and external iliac, common, superficial and deep femoral, popliteal, great saphenous, and short saphenous veins); and extra-corporeal circulation circuit for extra-corporeal membrane oxygenation (ECMO); or any combination thereof.

Such venous endovascular surgery techniques may be useful, for example, in the treatment of deep vein thrombosis, varicose veins (e.g., in the legs, pelvis and elsewhere), venous stenosis/narrowing, venous aneurysm, venous clots or venous trauma. Such conditions may be present in the cadaver, or they may be simulated in the cadaver. For example, blood clots may be simulated in a vein (or artery) using gelatinous thickening agents.

Certain embodiments of the disclosure will now be described with reference to one or more particular illustrative embodiments, which are not intended to limit the scope of the generality hereinbefore described.

In an exemplary embodiment, a submersible pump and may be connected to a first blood vessel, namely the ascending aorta, of a cadaver using wide bore plastic tubing. Preferably, the pump is a pulsatile pump. The pump may be placed in a perfusate reservoir housed within a first container. The perfusate may comprise warm tap water. Preferably, the tap water is heated to between about 30° C. and about 40° C. The perfusate may comprise a coloured glycerol-based thickening agent to replicate human blood. The perfusate may comprise a contrast agent.

To establish an inlet for the perfusate to enter the vascular system of the cadaver, access to the ascending aorta may be achieved using routine surgical techniques to expose the heart and ascending aorta, with optional removal of the pericardium (the protective, fluid-filled sac that surrounds the heart) and/or left lung. The small branches of the aorta may be clipped along the length of the artery within the chest. The ascending aorta may be surgically disconnected from the heart and the inside of the aorta may be washed with water and any residual debris within the aorta and its branches removed via the opening into the ascending aorta. Tubing from the pump may then be brought through the chest and connected directly into the aorta. The wide bore tubing from the pump may be secured to the ascending aorta using pipe clamps.

The cadaver model may be used to simulate arterial surgery techniques by establishing an outlet in one or more primary or higher order branches of the aorto-iliac arteries. The selection of arteries for providing an outlet (“outlet” arteries) may depend on the type of surgical technique to be simulated. For example, to establish an outlet for the perfusate to exit the cadaver through the arteries in the neck, the external and internal (extra-cranial portion) carotid arteries may be exposed using routine surgical techniques. To establish an outlet for the perfusate to exit the cadaver through the main arteries in the arm, the radial and ulnar arteries in each arm may be exposed using routine surgical techniques. To establish an outlet for the perfusate to exit the cadaver through the abdomen, the aorta and iliac arteries are first exposed using routine surgical techniques and the main branches of the aorta may be exposed using routine surgical techniques and the internal iliac arteries tied closed. The arteries to the liver, spleen, kidneys, small bowel and colon may also be exposed using routine surgical techniques. To establish an outlet for the perfusate to exit the cadaver through the main arteries in the legs, the anterior and posterior tibial and peroneal (and/or popliteal) arteries and the deep femoral arteries may be exposed using routine surgical techniques. The inside of each outflow artery, and those connecting them to the aorta, may be washed with water and any residual debris removed. The inside of each outflow artery (and any arteries connecting them to the aorto-iliac arteries) may then washed with water and any residual debris removed. Each artery may then be opened, and a wide bore surgical sheath inserted into each of the outlet arteries and secured in place with ties.

The cadaver model may be suitably adapted for simulating venous surgery techniques. In vivo, the venous system flows from the peripheral tissues back to the heart. Accordingly, in illustrative embodiments, the vascular models of the present disclosure may simulate venous blood flow by providing a flow of perfusate into one or more inlets in the main peripheral (“inlet”) veins back to the heart. Therefore, to establish an inlet for the perfusate into the cadaver, the perfusate may be pumped into an inlet vein of the cadaver.

The selection of inlet veins may depend on the type of surgical technique to be simulated. For example, to establish an inlet for the perfusate into the cadaver through the veins of the neck, the internal and external jugular veins may be accessed via routine surgical techniques. To establish an inlet for the perfusate into the cadaver through the veins of the arms, the brachial and/or axillary veins (at the level of the elbow) may be accessed via routine surgical techniques. To establish an inlet for the perfusate into the cadaver through the veins of the legs, the popliteal vein (below and behind the knee), saphenous veins (long and short; at or below the knee) and/or femoral vein may be accessed via routine surgical techniques. To establish an inlet for the perfusate into the cadaver through the veins of the abdomen, the inferior vena cava and iliac arteries may be exposed using routine surgical techniques. The main tributaries of the inferior vena cava may also be exposed using routine surgical techniques and the deep tributaries to the internal iliac veins tied closed. The veins to the liver, spleen, kidneys, and/or the inferior and superior mesenteric veins to the small bowel and colon may also be exposed using routine surgical techniques. The inside of each inlet vein (and any connected veins) may then be washed with water and any residual debris removed. Each vein may then be opened and a wide bore surgical sheath inserted into each of the outflow veins and secured in place with ties.

The perfusate may exit the cadaver through an outflow vein. The outflow vein may be the vena cava. For example, the superior and inferior vena cava may be exposed using routine surgical techniques and divided at the level of their connections to the heart. Any residual debris within the superior and inferior vena cava and their tributaries may be removed by washing with water. A branched tubing with the equivalent diameter of both the superior and inferior vena cava may be used to bridge the gap between the superior and inferior vena cava after their detachment from the heart. The branched tubing may keep the superior and inferior vena cava in continuity with each other and have a wide bore side branch as the main outlet from the venous system. A wide bore tubing may be connected to the side branch of the vena cava outflow tube. The used perfusate may be filtered through a sieve (i.e., to collect particulate matter) prior to being returned to the first container for recirculation into the cadaver.

In the vascular model for simulating arterial and/or venous surgery techniques, the wide bore outflow tubing may be connected to the first container. Upon exiting the cadaver perfusate may be filtered through a sieve (to collect particulate matter) prior to being returned to the first container for recirculation into the cadaver. In embodiments in which the perfusate comprises a contrast agent, the perfusate reservoir may be periodically replaced with clean perfusate to reduce build-up of the contrast agent. This may be achieved, for example, by temporarily diverting outflow to a second container and replenishing the first container with clean perfusate.

Pressure and/or leak testing of the cadaver model may be performed by selective clamping of each outflow blood vessel and pumping the perfusate through the inlet blood vessel, for example, at a pressure fluctuating between 0 mmHg and 200 mmHg for arterial models and at a pressure fluctuating between 0 mmHg and 50 mmHg for venous models. Pressure testing and/or leak testing may be performed visually and/or angiographically. Any leak may be sealed, for example, using surgical clips, ties and/or glues.

Those skilled in the art will be aware that the present disclosure is subject to variations and modifications other than those specifically described. It is to be understood that the present disclosure includes all such variations and modifications. The disclosure also includes all such steps, features, methods, compositions and compounds referred to or indicated in this specification, individually or collectively, and any and all combinations of any two or more of said steps or features.

1. A vascular model comprising a cadaver and an external drive unit in fluid communication with a vascular system of the cadaver and with a perfusate reservoir, wherein the vascular system includes an inlet through which perfusate enters an aorta and an outlet through which perfusate exits a primary or higher order branch of an aorto-iliac artery, and wherein the external drive unit is configured to generate a continuous flow of perfusate from the inlet to the outlet.

2. The vascular model according to claim 1, wherein the vascular system includes an outlet through which perfusate exits a primary branch of an aorto-iliac artery, optionally wherein the primary branch of the aorto-iliac artery is a brachiocephalic artery, a left common carotid artery, a left subclavian artery, an external iliac artery, an internal iliac artery, or any combination thereof, preferably the left common carotid artery.

3. (canceled)

4. (canceled)

5. The vascular model according to claim 1, wherein the vascular system includes an outlet through which perfusate exits a secondary or higher order branch of an aorto-iliac artery, optionally wherein the secondary or higher order branch of the aorto-iliac artery is a radial artery, an ulnar artery, a brachial artery, an axillary artery, a subclavian artery, an internal carotid artery, an external carotid artery, a coeliac trunk artery, a hepatic artery, a splenic artery, a renal artery, a superior mesenteric artery, an inferior mesenteric artery, an anterior tibial artery, a posterior tibial artery, a dorsalis pedis artery, a peroneal artery, a popliteal artery a common femoral artery, a deep femoral artery, a superficial femoral artery, or any combination thereof, preferably the common femoral artery, the deep femoral artery, the superficial femoral artery, or any combination thereof.

6-8. (canceled)

9. A vascular model comprising a cadaver and an external drive unit in fluid communication with a vascular system of the cadaver and with a perfusate reservoir, wherein the vascular system includes an inlet through which perfusate enters a vena cava, or a primary or higher order tributary thereof, and an outlet through which perfusate exits the vena cava, and wherein the external drive unit is configured to generate a continuous flow of perfusate from the inlet to the outlet, optionally wherein the vena cava is a superior vena cava, an inferior vena cava, or both.

10. (canceled)

11. The vascular model according to claim 9, wherein the vascular system includes an inlet through which perfusate enters a primary tributary of the vena cava, optionally wherein the primary tributary of the vena cava is a brachiocephalic vein, a lumbar vein, a right gonadal vein, a renal vein, a right suprarenal vein, a phrenic vein, a hepatic vein, or any combination thereof.

12. (canceled)

13. The vascular model according to claim 9, wherein the vascular system includes an inlet through which perfusate enters a secondary or higher order tributary of the vena cava, optionally wherein the secondary or higher order tributary of the vena cava is a cephalic vein, a basilic vein, a brachial vein, an axillary vein, a subclavian vein, an internal jugular vein, an external jugular vein, a popliteal vein, a saphenous vein, a femoral vein, an inferior phrenic vein, a common iliac vein, a portal vein, an internal iliac vein, an external iliac vein, a mesenteric vein, a deep femoral vein, a femoral vein, or any combination thereof.

15. The vascular model according to claim 9, wherein the external drive unit is a pump system.

16. The vascular model according to claim 9, wherein the perfusate:
(i) is at a temperature of between about 30° C. and about 40° C.; and/or
(ii) comprises water; and/or
(iii) comprises a thickening agent, a colouring agent and/or a contrast agent.

17. (canceled)

18. (canceled)

19. (canceled)

20. The vascular model according to claim 9, wherein the continuous flow of perfusate is:
(i) pulsatile; and/or
(ii) at a pressure of between about 0 mmHg and about 50 mmHg, or between about 0 mmHg and about 10 mmHg.

21. (canceled)

22. (canceled)

23. The vascular model according to claim 9, wherein the external drive unit is configured to recirculate the perfusate from the outlet to the inlet.

24. The vascular model according to claim 9, wherein an organ has been removed from the cadaver, optionally wherein the organ is a heart, a lung, a gut, or any combination thereof.

25. (canceled)

26. A vascular model comprising a cadaver and an external drive unit in fluid communication with a vascular system of the cadaver and with a perfusate reservoir, wherein the vascular system includes a first inlet through which perfusate enters an aorta and a first outlet through which perfusate exits a primary or higher order branch of an aorto-iliac artery, and a second inlet through which perfusate enters a vena cava, or a primary or higher order tributary thereof, and a second outlet through which perfusate exits the vena cava, and wherein the external drive unit is configured to generate a continuous flow of perfusate from the first inlet to the first outlet and from the second inlet to the second outlet.

27. The vascular model according to claim 26, wherein the external drive unit is configured to recirculate the perfusate from the first outlet of the primary or higher order branch of the aorto-iliac artery to the second inlet of the primary or higher order tributary of the vena cava.

28. (canceled)

29. A method for simulating a vascular surgery technique, the method comprising performing a vascular surgery technique on the vascular model according to claims 1, optionally wherein the vascular surgery technique is an endovascular surgery technique, preferably wherein the endovascular surgery technique is selected from:
endovascular arterial access via the upper limbs, neck, chest, abdomen, groin, and lower limbs;
testing and use of percutaneous arterial puncture closure devices; percutaneous and open endovascular arterial access and injury repair; diagnostic angiography; angioplasty;
embolization; atherectomy; thrombo-endarterectomy; stenting of arteries or their branches; and
extra-corporeal circulation circuit for extra-corporeal membrane oxygenation (ECMO); or any combination thereof.

30. (canceled)

31. (canceled)

32. A method for simulating a vascular surgery technique, the method comprising performing a vascular surgery technique on the vascular model according to claim 9, optionally wherein the vascular surgery technique is an endovascular surgery technique, optionally wherein the endovascular surgery technique is selected from: endovascular venous access via the upper limbs, neck, chest, abdomen, groin, and lower limbs; testing and use of percutaneous venous puncture closure devices; percutaneous and open endovascular venous access and injury repair; diagnostic angiography; angioplasty; embolization; atherectomy; thrombo-endarterectomy; radio-frequency ablation; application of laser, glue and sclerosing agents; stenting of veins and their tributaries; and extra-corporeal circulation circuit for extra-corporeal membrane oxygenation (ECMO); or any combination thereof.

33. The vascular model according to claim 1, wherein the external drive unit is a pump system.

34. The vascular model according to claim 1, wherein the perfusate:
(i) is at a temperature of between about 30° C. and about 40° C.; and/or
(ii) comprises water; and/or
(iii) comprises a thickening agent, a colouring agent and/or a contrast agent.

35. The vascular model according to claim 1, wherein the continuous flow of perfusate is:
(i) pulsatile; and/or
(ii) at a pressure of between about 0 mmHg and about 200 mmHg, or between about 50 mmHg and about 200 mmHg.

36. The vascular model according to claim 1, wherein the external drive unit is configured to recirculate the perfusate from the outlet to the inlet.

37. The vascular model according to claim 1, wherein an organ has been removed from the cadaver, optionally wherein the organ is a heart, a lung, a gut, or any combination thereof.
